(19) United States
(12) Patent Application Publication
(10) Pub. No.: US 2017/0051590 A1
(43) Pub. Date: Feb. 23, 2017

(54) Systems and Methods for Determining Forces on a Linear Permanent Magnet Motor Using Instantaneous Current Vectors

(71) Applicant: Baker Hughes Incorporated, Houston, TX (US)

(72) Inventors: Saylee p. Panchbhai, Houston, TX (US); Evan G. Mackay, Tulsa, OK (US)

(73) Assignee: Baker Hughes Incorporated, Houston, TX (US)

(21) Appl. No.: 15/238,368

(22) Filed: Aug. 16, 2016

Related U.S. Application Data
(60) Provisional application No. 62/207,806, filed on Aug. 20, 2015.

(51) Int. Cl. E21B 43/12; E21B 47/00; H02P 25/06; H02P 27/06; G01L 5/00; G01L 1/00

(52) U.S. Cl. CPC E21B 43/126; G01L 5/00; G01L 1/005; H02P 25/06; H02P 27/06; E21B 47/0007

(57) ABSTRACT

Systems and methods for determining the instantaneous force generated by a motor. In one embodiment, AC power (e.g., three-phase power) is provided to a linear motor of an ESP. An instantaneous current for each of the phases is measured at a particular point in time. These instantaneous current vectors are used to determine an instantaneous force by, for example, computing a root-mean-square of the instantaneous current vectors and multiplying the root-mean-square by a power factor. The instantaneous force computation may be performed successively for multiple, distinct points in time, and these computed force values may be used to form a graphical representation of the force generated by the linear motor over the stroke of the motor. The computed force values may also be used as the basis for controlling the motor.

### CROSS-REFERENCE TO RELATED APPLICATIONS

This application claims the benefit of U.S. Provisional Patent Application 62/207,806, filed Aug. 20, 2015 by Saylee P. Panchbhai, et al., which is incorporated by reference as if set forth herein in its entirety.

### BACKGROUND

Field of the Invention

The invention relates generally to linear permanent magnet motors, and more particularly to means for determining the force generated by a linear permanent magnet motor at a given point in time based on instantaneous current vectors of the power supplied to the motor.

Related Art

In the production of oil from wells, it is often necessary to use an artificial lift system to maintain the flow of oil. Artificial lift systems may utilize various different types of pumps to lift the oil out of the well. For instance, some conventional installations use rod lift systems in which a surface motor moves a sucker rod up and down in a reciprocating motion to drive a linear pump in the well. Other installations use electric submersible pumps (ESP's) in which a rotary motor and a pump are positioned downhole in the well to pump oil out of the well.

In an artificial lift system that uses a linear permanent magnet motor to lift oil from the well, it may be useful to be able to determine the amount of force that is being generated by the system. This information may be used, for example, to make adjustments to the speed at which the system's motor is operated. The amount of force being generated by the motor may also be used to determine whether the pump has encountered a gas pocket, or a pump-off condition prevails (when the pump takes in excess gas in comparison to liquid, and fluid pounding occurs as a result).

In a pump system that uses a sucker rod, it is necessary to incorporate a strain gauge or some other type of load cell into the system to measure the pumping force. This load measuring component of the system requires a force measurement device, along with a physical assembly on the sucker rod pump. This makes the entire system more bulky and expensive. In the case of an ESP that uses a rotary motor, it is possible to determine the lifting force generated by the ESP's pump based on the current which is drawn by the motor. Conventional techniques for determining force from the motor's electric current, however, are based on the rotary motion of the motor and are not valid for linear motors.

It would therefore be desirable to provide systems and methods for determining the force generated by an ESP that is operated by a linear permanent magnet motor.

### SUMMARY OF THE INVENTION

This disclosure is directed to systems and methods for determining the instantaneous force generated by a linear motor that solve one or more of the problems discussed above. One particular embodiment comprises a method in which AC power is provided to a linear motor of an ESP. The AC power may have one or more (e.g., three) phases. An instantaneous current for each of the phases of the AC power is measured at a particular point in time. These instantaneous current vectors are used to determine an instantaneous force at that instant. The instantaneous force may be determined, for example, by computing a root-mean-square of the instantaneous current vectors and multiplying the root-mean-square by a force factor, which is a force constant of the motor provided by the manufacturer. It should be noted that this is the root-mean-square of the instantaneous current vectors at the desired instant in time, and not a conventional root-mean-square computation of the currents over some time interval. The instantaneous force computation may be performed successively for multiple, distinct points in time, and these computed force values may be used to form a graphical representation of the force generated by the linear motor over the stroke of the motor. The computed force values may also be used as the basis for controlling the motor (e.g., shutting down the motor if a threshold force is exceeded.)

An alternative embodiment comprises an artificial lift system. The system includes an ESP which is installed in a well, an electric drive which is positioned at the surface of the well, and a power cable which is coupled between the electric drive and the ESP. The ESP uses a linear motor to drive a reciprocating pump. The electric drive includes a set of current sensors which are coupled to the output of the electric drive to measure the current of the AC output power. If the AC output power is multi-phase (e.g., three-phase), the current of each phase is separately determined. The instantaneous currents of the phases are used by the electric drive (e.g., by a controller of the drive) to determine an instantaneous force generated by the linear motor. In a system using multi-phase power, the instantaneous current of each phase is determined, and the root-mean-square of the currents is computed and multiplied by a force factor to produce the instantaneous force. This instantaneous force may be displayed to a user or it may be used by the drive to control the output of the drive. The instantaneous force may be determined for multiple points over the stroke of the linear motor, and these force values may be used to graphically represent the force generated by the motor over its stroke, or as a function of time.

Another alternative embodiment comprises an electric drive for an ESP having a linear motor. The electric drive generates AC output power to drive the linear motor. The drive may, for example, include a converter to convert input AC power to DC power, a DC bus to which the DC power is provided, and an inverter that draws DC power from the bus and produces three-phase output power for the linear motor. A set of current sensors are coupled to the output of the electric drive to measure the current of each phase of the AC output power. The drive includes a controller that receives instantaneous current measurements from the current sensors. The controller determines an instantaneous force generated by the motor based on the instantaneous currents. In one embodiment, the controller determines the instantaneous force by computing a root-mean-square of the instantaneous current vectors and multiplying the root-mean-square by a power factor. The controller may then control the drive (e.g., the converter and inverter) based on the instantaneous force to control the AC power provided to the linear motor. Alternatively, the drive may provide the force as an output to a user. The instantaneous force may be determined at multiple, distinct points in time.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating an exemplary pump system in accordance with one embodiment.

FIG. 2 is a diagram illustrating an exemplary linear motor in accordance with one embodiment which would be suitable for use in the pump system of FIG. 1.

FIG. 3 is a functional block diagram illustrating the structure of a control system for a linear motor in accordance with one embodiment.

FIG. 4 is a flow diagram illustrating a method for determining the instantaneous force generated by a motor based on instantaneous current vectors of a drive system's output in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims. Further, the drawings may not be to scale, and may exaggerate one or more components in order to facilitate an understanding of the various features described herein.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for determining the force generated by a linear permanent magnet motor at a given point in time based on instantaneous current vectors of the power supplied to the motor. In one embodiment, the motor, which is positioned downhole in a well with a linear pump, is driven by three-phase power received from a drive system at the surface of the well. The drive system monitors the current that is drawn by the motor. Instantaneous current values for each of the three phases are determined using analog-to-digital converters (ADC's), and the square root is taken of the sum of the squares of these instantaneous phase currents, divided by three, producing an instantaneous current vector (ICV). The instantaneous current vector is then multiplied by a constant force factor to produce an instantaneous force value. The force can be determined in this manner for any point in time, and can be computed at regular intervals, or on an as-needed basis.

The present systems and methods for determining the force of the linear motor have a number of advantages over the prior art. For instance, these systems and methods do not require that load sensors be coupled to a sucker rod, and do not require any other physical assembly to be coupled to a surface mounted linear motor, as is the case with traditional sucker rod systems. The present systems and methods are therefore simpler and less costly than traditional sucker rod systems. In comparison to ESP's that use rotary motors, the present systems and methods can determine currents and the corresponding force at any instant. The present systems and methods therefore provide the advantage of being able to determine the dynamically changing force in a linear motor over the length of a single stroke.

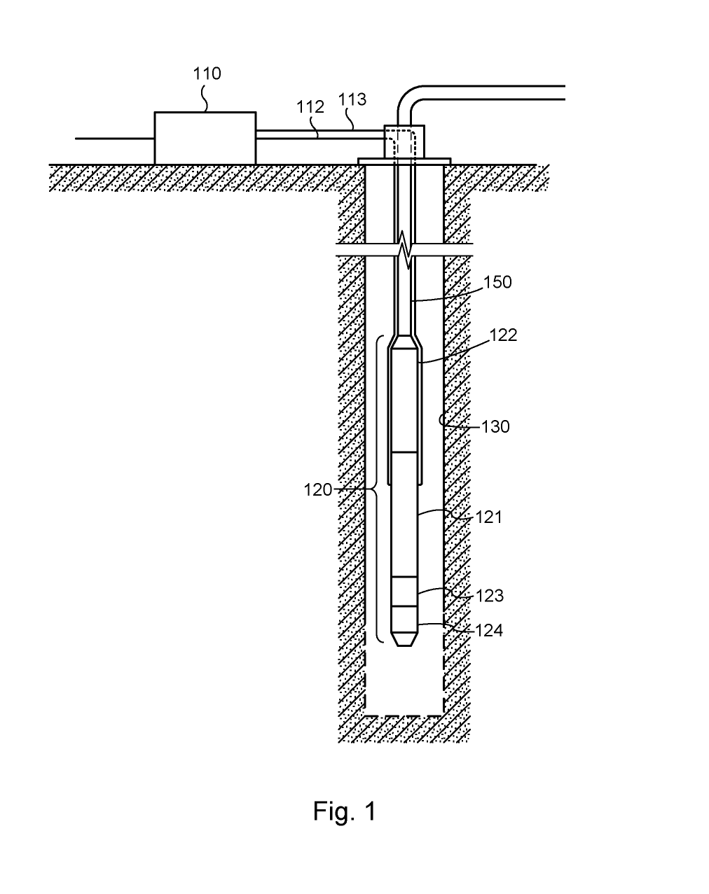

Referring to FIG. 1, a diagram illustrating an exemplary pump system in accordance with one embodiment of the present invention is shown. A wellbore 130 is drilled into an oil-bearing geological structure and is cased. The casing within wellbore 130 is perforated in a producing region of the well to allow oil to flow from the formation into the well. Pump system 120 is positioned in the producing region of the well. Pump system 120 is coupled to production tubing 150, through which the system pumps oil out of the well. A control system 110 is positioned at the surface of the well. Control system 110 is coupled to pump 120 by power cable 112 and a set of electrical data lines 113 that may carry various types of sensed data and control information between the downhole pump system and the surface control equipment. Power cable 112 and electrical lines 113 run down the wellbore along tubing string 150.

Pump 120 includes an electric motor section 121 and a pump section 122. In this embodiment, an expansion chamber 123 and a gauge package 124 are included in the system. (Pump system 120 may include various other components which will not be described in detail here because they are well known in the art and are not important to a discussion of the invention.) Motor section 121 receives power from control system 110 and drives pump section 122, which pumps the oil through the production tubing and out of the well.

In this embodiment, motor section 121 is a linear electric motor. Control system 110 receives AC (alternating current) input power from an external source such as a generator (not shown in the figure), rectifies the AC input power and then converts the DC (direct current) power to produce three-phase AC output power which is suitable to drive the linear motor. The output power generated by control system 110 is dependent in part upon the position of the mover within the stator of the linear motor. Position sensors in the motor sense the position of the mover and communicate this information via electrical lines 113 to control system 110 so that the mover will be driven in the proper direction (as will be discussed in more detail below). The output power generated by control system 110 is provided to pump system 120 via power cable 112.

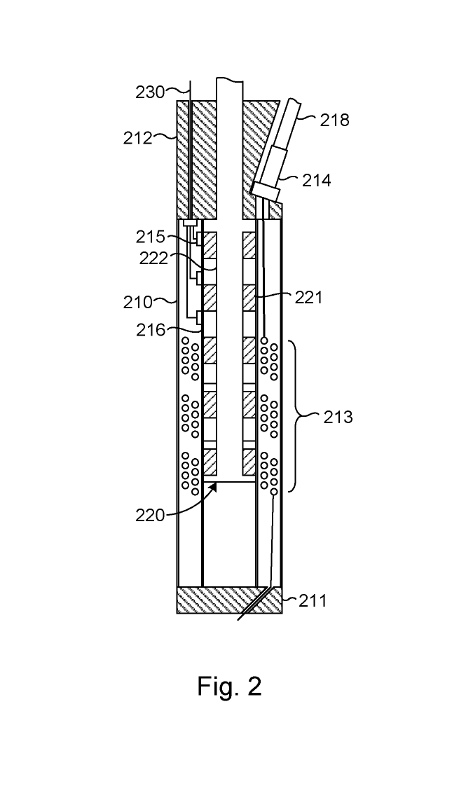

Referring to FIG. 2, a diagram illustrating an exemplary linear motor which would be suitable for use in the pump system of FIG. 1 is shown. The linear motor has a cylindrical stator 210 which has a bore in its center. A base 211 is connected to the lower end of stator 210 to enclose the lower end of the bore, and a head 212 is connected to the upper end of the stator. Motor head 212 has an aperture therethrough to allow the shaft 222 of the mover 220 to extend to the pump.

Stator 210 has several coils (e.g., 213) of electrically conductive magnet wire that are positioned around an inner support core 216 that forms the bore of the stator. The coils form multiple poles within the stator. The number of coils and the number of poles may vary from one embodiment to another. The ends of the windings are coupled (e.g., via a pothead connector 214) to the conductors of the power cable 218. Although the power cable has separate conductors that carry the power to the motor, the conductors are not depicted separately in the figure for purposes of simplicity and clarity.

The windings are alternately energized by the current received through the power cable to generate magnetic fields within the stator. These magnetic fields interact with permanent magnets 221 on the shaft 222 of mover 220, causing mover 220 to move up and down within the motor. The waveform of the signal provided by the drive via the power cable is controlled to drive mover 220 in a reciprocating motion within the bore of stator 210. Stator 210 may incorporate one or more Hall-effect sensors 215 to monitor the electrical position of mover 220 within stator 210.

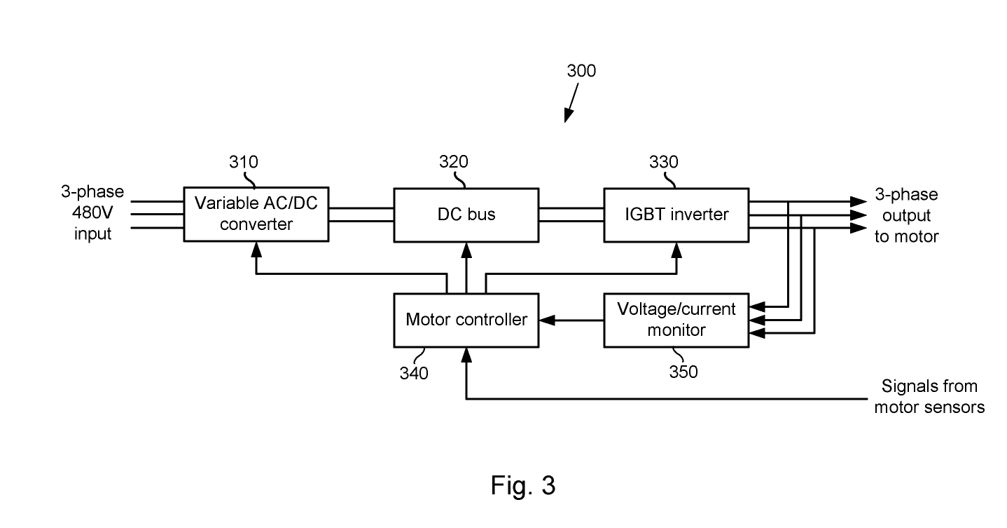

Referring to FIG. 3, a functional block diagram illustrating the structure of a control system for a linear motor in one embodiment is shown. The control system is incorporated into a drive system for the linear motor. The drive system receives AC input power from an external source and generates three-phase output power that is provided to the linear motor to run the motor. The drive system also monitors the current drawn by the motor and uses instantaneous current vectors to determine the instantaneous force generated by the motor. The operation of the motor can then be controlled as needed in accordance with the generated force information.

As depicted in FIG. 3, drive system 300 has a variable AC/DC converter that receives AC input power from the external power source. The input power may be, for example, 480V, three-phase power. Circuitry 310 converts the received AC power to DC power and provides this power to a DC bus 320. The DC power on DC bus 320 is input to an inverter 330 which may use, for example IGBT switches to produce three-phase output power at a desired voltage and frequency. The output power produced by inverter 330 is transmitted to the downhole linear motor via a power cable.

The power output by inverter 330 is monitored by voltage and current sensors 350 installed on the output of the drive. Sensors 350 provide a signal which indicates the current drawn by the linear motor as an input to motor controller 340. Motor controller 340 may also receive information from the downhole linear motor (e.g., position signals from hall sensors in the motor) and/or other equipment positioned in the well. This information may be provided to an operator, and/or it may be used by motor controller 340 to control the output power that is generated by drive system 300. Motor controller 340 may include a microprocessor, CPU, memory, input/output devices or various other components to enable the controller to perform its control functions and computations.

In one embodiment, motor controller 340 is configured to make a determination of the instantaneous force that is being generated by the motor. The force can be determined at any point in time. Force determinations can be made repeatedly, and at very short intervals. For example, the force can be determined every 0.5 milliseconds. Repeated force determinations can be used to build DynaGraphs (charts or graphical representations of force as a function of the position of the motor's mover for a linear motor). If the force is determined to exceed an upper threshold, the controller may shut down the motor in order to prevent damage to the motor. If the force is determined to fall below a lower threshold, this may indicate a gas pocket or a pump-off condition, and the controller may adjust operation of the motor in response to these conditions.

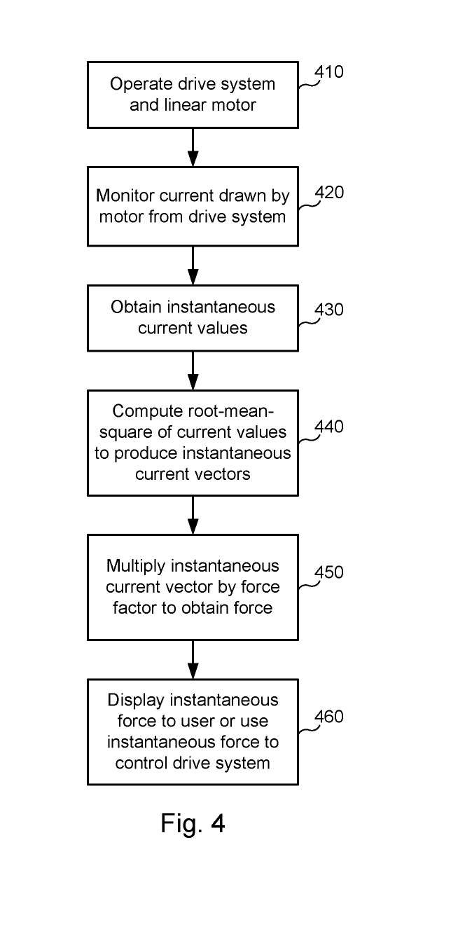

Referring to FIG. 4, a flow diagram illustrating an exemplary method for determining the instantaneous force of the motor is shown. As depicted in this figure, the drive system is operated to produce output power that is provided to the linear motor in order to operate the motor (410). The controller of the drive system monitors the system's output power, and in particular monitors the current drawn by the linear motor (420). As the system is operating, the controller obtains instantaneous current values for each of the three phases of the output power (430). The controller computes the root-mean-square of the three instantaneous current values (440) as shown in equation 1 below. The root-mean-square is then multiplied by a constant force factor to produce the instantaneous force of the linear motor (450) as shown in equation 2. This process may be repeated as desired to determine the force of the motor at any given point (or at any set of points) in time.

$$ICV = \sqrt{\frac{{( Ainst )}^{2} + {( Binst )}^{2} + {( Cinst )}^{2}}{3}} \qquad ( 1 )$$

where:
ICV=instantaneous current vector;
Aᵢₙₛₜ=instantaneous phase current for phase A;
Bᵢₙₛₜ=instantaneous phase current for phase B;
Cᵢₙₛₜ=instantaneous phase current for phase C.

Force=k_{f}*ICV (2)

where:
K_{f}=constant force factor (or motor constant).

It should be noted that the root-mean-square of the instantaneous phase current values is distinct from the root-mean-square (RMS) of one or more waveforms. The conventional RMS value of a waveform is effectively the average magnitude of the waveform over one or more periods. The root-mean-square computation used in the present systems and methods is a product of the current values at a particular instant in time, rather than averages of the currents for the different phases.

As noted above, the instantaneous force can be used in various ways, including providing this information to a user/operator, generating graphs or charts of force as a function of time or mover position, shutting down the motor if the force indicates a hazardous condition, adjusting the output of the drive system, or taking some other action (460).

The systems and methods described herein for determining the instantaneous force generated by a linear motor have several advantages over prior art means for determining a motor's force. For example, ESP's typically use rotary motors, and use conventional techniques for determining the torque generated by the rotary motors. These techniques typically involve vector control systems. In such a system, currents flowing through the three different phases of the motor are transformed to generate two-dimensional vectors in a stationary frame of reference referred to as D-Q space. The motor current and voltage are represented by two dimensional vectors in the D-Q plane, and the torque generated by the motor is computed from these vectors. Because the mover of a linear motor moves in a reciprocating linear motion rather than a rotary motion and does not provide any rotor angle information which is essential for the D-Q transformation, the conventional transformation of the current-voltage vectors to the D-Q space is not possible and cannot be used.

The present systems and methods also have advantages with respect to conventional techniques for determining force in linear pump systems. Some traditional artificial lift systems use surface motors that are connected to sucker rod pumps. In these systems, a strain gauge or other type of load cell and a measurement device are coupled to the pump to measure the pumping force. These components are bulky and costly. The present systems and methods, on the other hand, are implemented using the drive's motor controller and current sensors, so they do not add to the bulk of the system or significantly increase the cost.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method comprising:
providing AC power to a linear motor of an electric submersible pump (ESP), wherein the AC power has one or more phases;
measuring an instantaneous current of each of the one or more phases of the AC power provided to the linear motor;
determining an instantaneous current vector for each of the one or more phases of the AC power provided to the linear motor based on the measured instantaneous currents; and
determining an instantaneous force generated by the linear motor based on the instantaneous current vectors.

2. The method of claim 1, further comprising controlling the AC power provided to the linear motor based on the instantaneous force.

3. The method of claim 1, wherein the AC power provided to the linear motor comprises three-phase AC power.

4. The method of claim 1, wherein the instantaneous force for a point in time is determined by computing a root-mean-square of the instantaneous current vectors for the point in time and multiplying the root-mean-square by a force factor.

5. The method of claim 1, further comprising determining the instantaneous force generated by the linear motor at multiple distinct points in time during a single stroke of the linear motor.

6. The method of claim 5, generating a graphical representation of the force generated by the linear motor over the single stroke of the linear motor and providing the graphical representation to a user display device.

7. An apparatus for determining an instantaneous force of a linear motor, the apparatus comprising:
an electric drive which generates AC output power;
one or more current sensors coupled to an output of the electric drive, wherein the sensors measure one or more currents of the AC output power; and
a controller coupled to the electric drive and the current sensors, wherein the controller:
receives instantaneous current measurements from the current sensors,
determines an instantaneous current vector for each of one or more phases of the AC output power based on the measured instantaneous currents,
determines an instantaneous force based on the instantaneous current vectors, and
controls the AC power provided to the linear motor based on the instantaneous force.

8. The apparatus of claim 7, wherein the electric drive generates three-phase AC power.

9. The apparatus of claim 8, wherein the controller determines the instantaneous force for a point in time by computing a root-mean-square of the instantaneous current vectors of each of the three phases for the point in time and multiplying the root-mean-square by a power factor.

10. The apparatus of claim 8, wherein the electric drive generates AC power alternately with a first phase rotation for a power stroke and a second phase rotation for a return stroke wherein the controller determines the instantaneous force generated by the linear motor at multiple distinct points in time during a single power stroke.

11. The apparatus of claim 7, wherein the electric drive comprises:
a converter which receives input AC power and converts the input AC power to DC power;
a DC bus coupled to receive the DC power from the converter; and
an inverter coupled to receive the DC power from the DC bus and to invert the received DC power, thereby generating the AC output power.

12. A system comprising:
an electric submersible pump (ESP) installed in a well;
an electric drive positioned at the surface of the well; and
a power cable coupled between the electric drive and the ESP;
wherein the electric drive includes one or more current sensors coupled to an output of the electric drive, wherein the sensors measure one or more currents of the AC output power; and
wherein the electric drive includes a controller that receives instantaneous current measurements from the current sensors, determines an instantaneous current vector for each of one or more phases of the AC output power based on the measured instantaneous currents, and determines an instantaneous force based on the instantaneous current vectors.

13. The system of claim 12, wherein the controller controls AC power generated by the electric drive based on the instantaneous force.

14. The system of claim 12, wherein the controller determines the instantaneous force for a point in time by computing a root-mean-square of the instantaneous current vectors for the point in time and multiplying the root-mean-square by a power factor.

15. The system of claim 12, wherein the controller determines the instantaneous force generated by the linear motor at multiple distinct points in time during a single stroke of the linear motor.
